(19) United States
(12) Patent Application Publication
(10) Pub. No.: US 2011/0091984 A1
(43) Pub. Date: Apr. 21, 2011

(54) ANALYTICAL METHOD TO MONITOR VACCINE POTENCY AND STABILITY

(76) Inventors: Mark D. Williams, Lawrence, KS (US); James Slightom, Lawrence, KS (US); Frank Roerink, DeSoto, KS (US)

(21) Appl. No.: 12/994,251

(22) PCT Filed: May 21, 2009
(86) PCT No.: PCT/US09/44775

§ 371 Date: Nov. 23, 2010

Related U.S. Application Data
(60) Provisional application No. 61/057,346, filed on May 30, 2008.

(51) Int. Cl. G01N 30/02

(52) U.S. Cl. 436/161

(57) ABSTRACT

The present invention is directed to methods of evaluating whether an antigen or vaccine has degraded over time using liquid chromatography. The methods described herein also relate to using liquid chromatography to evaluate the relative potency of a given antigen or vaccine.

### FIELD OF THE INVENTION

The present invention is directed to methods of evaluating whether a vaccine has degraded over time using liquid chromatography. The methods described herein also relate to using liquid chromatography to evaluate the potency of antigen in a given sample.

### BACKGROUND OF THE INVENTION

Numerous quality control considerations present themselves in the production process of vaccine manufacturing. Viral, bacterial or parasitical vaccines must be formulated from cultured material that can vary in a variety of respects from batch to batch. Among the quality control problems that can arise is the issue of assuring that new batches of vaccine have the requisite level of potency. A related concern is the issue of whether stores of inventoried batches or lots of antigen or vaccine retain the requisite level of potency or have degraded over time prior to distribution or use.

It is impractical to conduct clinical trials for every batch of manufactured vaccine. Such trials would not only be time consuming and expensive, but would also require unnecessary human or animal testing. Instead, vaccine manufacturers rely upon a reference vaccine against which newly produced batches of vaccines can be compared. The reference vaccine is typically stored in very cold conditions (e.g., −70° C.) so as to reduce or eliminate any vaccine degradation.

Once the efficacy of the reference vaccine is established directly or indirectly through human or animal clinical studies, an in vitro or in vivo assay can be used to correlate its efficacy to its potency. The relative potency of newly produced vaccine batches can be compared to the relative potency of the reference vaccine, for example, via an ELISA assay. Likewise, changes in the stability of the reference vaccine or the newly produced vaccine batches can also be monitored via an ELISA assay.

There remain, however, several problems in relying upon a reference vaccine to assure the quality of newly produced vaccine. As indicated above, the reference vaccine can degrade over time and periodically needs to be reestablished by way of time-consuming new human or animal clinical studies. Even where the reference vaccine degrades slowly, governmental regulatory requirements often impose expiration dates for the reference vaccine material. Thus, periodic qualification of vaccines or re-qualification of reference vaccines can be time consuming and expensive as qualification typically requires human or animal studies to establish a vaccine's efficacy.

Furthermore, interference amongst antigens can arise when using immunologically-based assays to evaluate the potency of multivalent vaccines. Such interference can make assessment of the relative potency of a newly manufactured multivalent vaccine difficult or impossible.

Accordingly, there is a need for quality control methods that avoid these problems.

### SUMMARY OF THE INVENTION

The present invention provides a method by which the stability or potency of an antigen or vaccine can be measured using liquid chromatography.

In one embodiment, the present invention is directed to a method of measuring antigen stability comprising: i) gathering a first liquid chromatography measurement of antigen contained in a first sample prepared from a source of antigen; ii) gathering a second liquid chromatography measurement of antigen contained in a second sample prepared from the source of antigen; and iii) quantifying changes in the second liquid chromatography measurement as compared to the first liquid chromatography measurement thereby measuring antigen stability. An internal standard can be added to the samples. The measurements can be derived from recorded peaks showing the amount of light absorption or fluorescence emission of antigen and internal standard. The first liquid chromatography measurement can be a ratio of the area under the peak of antigen of the first sample to the normalized area under the peak of internal standard of the first sample; and the second liquid chromatography measurement can be a ratio of the area under the peak of antigen of the second sample to the normalized area under the peak of internal standard of the second sample. The source of antigen can be a vaccine batch. The samples can be prepared by separating antigen from adjuvant in samples taken from the vaccine batch. The antigen can be precipitated in the samples taken from the vaccine batch. Alternatively, the adjuvant can be precipitated in the samples taken from the vaccine batch.

In another embodiment, the invention is directed to a method of measuring vaccine batch potency relative to the potency of a corresponding reference vaccine comprising i) gathering a first liquid chromatography measurement of antigen contained in a first sample prepared from the reference vaccine; ii) gathering a second liquid chromatography measurement of antigen contained in a second sample prepared from the vaccine batch; iii) comparing the second liquid chromatography measurement to the first liquid chromatography measurement thereby determining the vaccine batch potency relative to the potency of the corresponding reference vaccine. An internal standard can be added to the samples. The measurements can be derived from peaks showing the amount of light absorption or fluorescence emission of antigen and internal standard. The first liquid chromatography measurement can be a ratio of the area under the peak of antigen of the first sample to the normalized area under the peak of internal standard of the first sample; and the second liquid chromatography measurement can be a ratio of the area under the peak of antigen of the second sample to the normalized area under the peak of internal standard of the second sample. The first sample and the second sample can respectively be prepared by separating antigen from adjuvant in samples taken from the reference vaccine and the vaccine batch. The antigen can be precipitated in the samples taken from the reference vaccine and the vaccine batch. Alternatively, the adjuvant can be precipitated in the samples taken from the reference vaccine and the vaccine batch.

In yet another embodiment, the invention is directed to a method of qualifying a vaccine batch as a reference vaccine comprising i) gathering a first liquid chromatography measurement of antigen contained in a first sample prepared from a reference vaccine; ii) gathering a second liquid chromatography measurement of antigen contained in a second sample prepared from the vaccine batch; iii) comparing the second liquid chromatography measurement to the first liquid chromatography measurement thereby determining the vaccine batch potency relative to the potency of the corresponding reference vaccine; wherein the vaccine batch is qualified as a reference vaccine when the second liquid chromatography measurement is at least the same as the first liquid chromatography measurement.

In yet another embodiment, the invention is directed to a method of requalifying a reference vaccine comprising: i) gathering a first liquid chromatography measurement of antigen contained in a first sample prepared from a source of antigen; ii) gathering a second liquid chromatography measurement of antigen contained in a second sample prepared from the source of antigen; and iii) quantifying changes in the second liquid chromatography measurement as compared to the first liquid chromatography measurement thereby measuring antigen stability; wherein the source of antigen is a previously qualified reference vaccine and the reference vaccine is requalified when the second liquid chromatography measurement is at least the same as the first liquid chromatography measurement.

### BRIEF DESCRIPTION OF THE FIGURES

FIG. 1: Representative HPLC chromatogram of an HPLC sample prepared from Neospora caninum vaccine prior to addition of the fenbendazole internal standard obtained using the methods of Example 1.

FIG. 2: Representative HPLC chromatogram of the isolated fraction of Neospora caninum confirmed to show a response using the ELISA assay obtained using the methods of Example 1. The peak around 3.7 minutes corresponds to the antigen.

FIG. 3: Representative HPLC chromatogram of fenbendazole internal standard obtained using the methods of Example 1. The peak around 5 minutes corresponds to the internal standard.

FIG. 4: Representative chromatogram of Neospora caninum vaccine with fenbendazole internal standard obtained using the methods of Example 1. There is no overlap between the antigen peak around 3.7 minutes and the internal standard peak around 5 minutes.

FIG. 5: Plot of detector response measured as peak area ratio vs. concentration of Neospora caninum antigen over the range of 1.0% to 5.0% concentrated antigen.

FIG. 6: Correlation of normalized peak area ratios as determined using HPLC method of Example 1 with ELISA Potency Assay for respective samples.

FIG. 7: Representative HPLC chromatogram of an HPLC sample prepared from Mycoplasma hyopneumoniae vaccine prior to addition of the DPP internal standard obtained using the methods of Example 2.

FIG. 8: Representative chromatogram of purified Mycoplasma hyopneumoniae antigen (p44) obtained using the methods of Example 2. The protein used in this sample was solubilized from a band isolated via polyacrylamide gel electrophoresis (PAGE). The peak around 5 minutes corresponds to antigen. The very large peak around 15.5 minutes corresponds to buffer in which the antigen was placed, but which is not normally present in the vaccine.

FIG. 9: Representative chromatogram of DPP internal standard obtained using the methods of Example 2. The DPP peak appears around 15 minutes.

FIG. 10: Representative chromatogram of Mycoplasma hyopneumoniae vaccine with DPP internal standard obtained using the methods of Example 2. There is no overlap between the antigen peak around 5 minutes and the internal standard peak around 15 (14.8) minutes.

FIG. 11: Plot of detector response measured as peak area ratio vs. concentration of mycoplasma hyopneumoniae antigen over the range of 1.0% to 24% concentrated antigen.

FIG. 12: Representative chromatogram showing porcine circovirus (PCV) antigenic peak around 6.7 minutes from an HPLC sample prepared from a PCV/Mycoplasma hyopneumoniae combination vaccine sample. This chromatogram does not contain any phthalic acid internal standard.

FIG. 13: Representative chromatogram showing porcine circovirus (PCV) antigenic peak around 6.7 minutes from an HPLC sample prepared from a PCV/Mycoplasma hyopneumoniae combination vaccine sample. Phthalic acid internal standard was added to this sample and its peak occurs around 4.3 minutes.

### DETAILED DESCRIPTION OF THE INVENTION

The present invention provides a method by which the stability or potency of an antigen or vaccine can be measured using liquid chromatography. In one embodiment, the present invention employs liquid chromatography to observe or monitor any degradation in antigen from some antigen source over time. In another embodiment, the present invention employs liquid chromatography to compare the potency of antigen from one source to the potency of antigen from another source.

The source of antigen can come from any stage of the vaccine production process. Hence, the source of antigen can be material that is in the process of being cultured. The source of antigen can also be material that has achieved a cell, parasite or viral density such that the yield is deemed to be sufficient to consider the culturing complete or optimized. The source of antigen can be concentrated or harvested from the culture. Alternatively, the source of the antigen can be an extract from the culture or partially or fully purified component of the culture. The antigen itself can be live, attenuated live or inactivated. The source of the antigen can also be a partially or completely finished vaccine product. The source of antigen can be biological product in bulk or final container produced to final form and composition; a completed product which has been bottled, sealed, packaged, and labeled; or a finished product released for marketing.

Antigen from the same source represents all antigen that can be grouped together due to its uniformity. Antigen from the same source can include just the material within a single container of a cultured batch of antigen. Alternatively, antigen from the same source can include multiple batches of cultured antigen that have been thoroughly mixed together, or formulated vaccine made from separate batches of cultured antigen that is thoroughly mixed together during formulation prior to individual packaging. A single uniform batch of cultured material can be partitioned to make separate batches, lots or serials of vaccines. Individual packages of vaccines made from different partitions of the cultured material may still be regarded as containing antigen from the same source, provided that their formulation was prepared with the same or similar materials in the same or a similar manner.

Different samples of antigen can come from the same source yet be at different stages of processing. For example, half of a cultured batch of antigen may be harvested and stored while the other half is processed through to the final stage of finished vaccine product. As discussed further below, the potency or stability of antigen from any stage of processing can be measured by the techniques described herein. Samples of antigen from different stages of the vaccine production process can be used where the relative antigen potency is being measured. Indeed, where the relative antigen potency is being measure, a sample of antigen from one source can be compared against a sample of antigen from another source, and the two samples can be from the same or different stages of the vaccine production process. In contrast, however, it is preferable to use material from the same source and from the same production process stage where antigen stability is being measured.

With liquid chromatography, a sample is loaded onto a solid phase. The sample (or, liquid chromatography sample) is typically prepared as a liquid sample so as to enter the solid phase as uniformly as possible. The liquid chromatography sample is typically a small volume relative to the size of the solid phase or the amount of mobile phase passing through the solid phase. The volume of the liquid chromatography sample is typically not greater than 5% of the volume of the solid phase, and often not greater than 1% or 2% of the solid phase. “Liquid” and like terms as used herein refer to a fluid substance that is non-gaseous and non-solid.

The components (including the antigen or any internal standard) within the liquid chromatography sample bind to the solid phase. The liquid mobile phase passing through the solid phase changes during the liquid chromatography method by employing a solvent gradient of two or more liquids. This gradient variably changes the binding affinity of the components within the liquid chromatography sample for the solid phase. Such a gradient allows the sample to separate on the solid phase which affords the collection of the samples' constituent parts (or, fractions) at distinct times. Hence, the liquid mobile phase can be optimized to cause the antigen or any internal standard used to pass through the solid phase separately from other components within the sample.

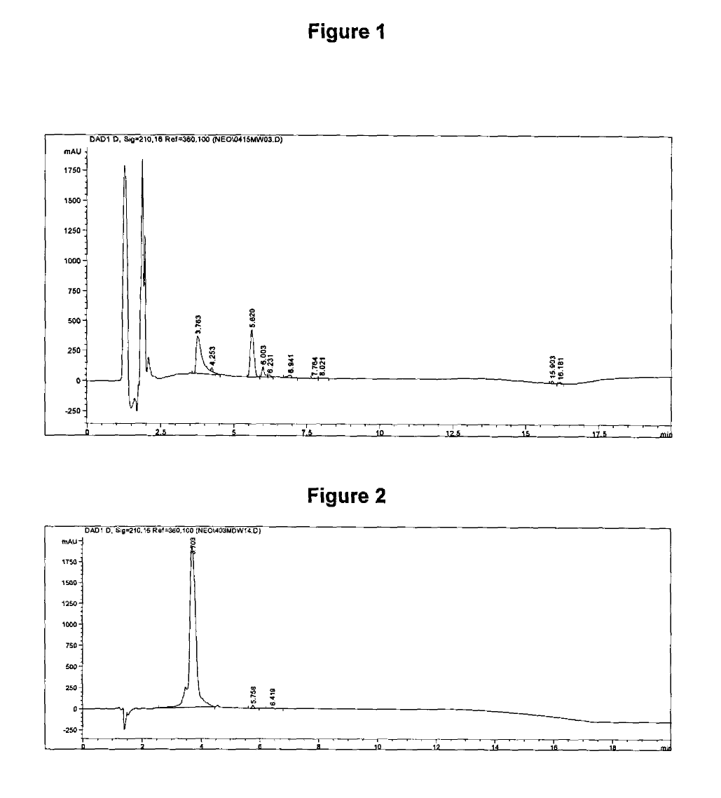

In an embodiment of the invention, the liquid chromatography technique employs column chromatography methodology. Such methodology preferably includes a pump that causes the mobile phase to pass through the solid phase at a uniform rate, and a light source and detector to observe and record spectroscopic changes (e.g., absorption, fluorescence, phosphorescence, etc.) in the sample fractions passing through and coming off of the solid phase. In one embodiment of the invention, the liquid chromatography employs high pressure liquid chromatography (HPLC, also termed high performance liquid chromatography). However, the skilled artisan is familiar with other chromatography technologies to which the present invention would be applicable. Fractions of the liquid chromatography sample emerge from the solid phase at different times due to the progressively changing constitution of the mobile phase caused by the solvent gradient. A detector mated to the liquid chromatography apparatus observes whether fractions emerging from the solid phase at any given time are spectroscopically active (e.g., absorb light, fluoresce or phosphoresce, etc.). Fractions that are spectroscopically active give rise to a peak on the chromatogram (i.e., a recording of spectroscopically active material emerging from the solid phase; see e.g., FIGS. 1-4, 7-10, 12 and 13). The peak corresponding to antigen can be used as described herein to evaluate antigen stability or potency in a given sample.

In one aspect of the present invention, liquid chromatography is used to measure the stability of an antigen. The stability of an antigen can be measured by observing changes in the spectroscopic chromatogram obtained from liquid chromatography of the antigen over time. Measuring stability requires at least two liquid chromatography measurements of antigen from the same source, but at different times. A first measurement is made at a first time followed by a second measurement at a second time. The measurements may be made hours, days, months or years apart. In order to obtain a measurement of the stability, however, the liquid chromatography measurements must be performed in a uniform manner, and must be taken from liquid chromatography samples derived from the same source of antigen which are preferably at the same stage of processing. Preferably, replicate liquid chromatography measurements are taken for each liquid chromatography sample so as to obtain accurate measurements.

Where an external standard having a quantified concentration or amount of antigen is not available, an internal standard (I.S.) must be used against which changes in the stability of the antigen can be measured. Use of internal standard affords measurement of the relative stability: i.e., the amount of antigen in a source of sample at one point in time relative to the amount of antigen in the same source at another time. In such a process, a first liquid chromatography sample is prepared from the source of antigen that includes an internal standard. The internal standard yields a liquid chromatography signal that does not interfere with the liquid chromatography signal arising from the antigen. The peak area of the internal standard is normalized based upon the weight of internal standard used to make the liquid chromatography sample, and a normalized peak area ratio (NPAR) of antigen to internal standard can be recorded. The formula for calculating the NPAR is as follows:

NPAR=[(Peak Area of antigen)/(Peak Area of I.S.)]×(wt. of I.S.)/(ideal wt. of I.S.)

The “wt. of I.S.” is the weight of internal standard actually measured that was used to prepare the sample; and “ideal wt. of I.S.” is the normalizing weight of internal standard that affords chromatograms having non-saturated peak areas on a similar or close order of magnitude as the peak areas for the antigen. As used herein, “NPAR” and “weight normalized peak area ratio” are synonymous. NPAR and all other peak area ratios described herein refer to the ratio of the area under the curve resulting from the antigen to the weight-normalized area under the curve resulting from the internal standard.

Preferably, replicate measurements of the NPAR are recorded for a first liquid chromatography sample prepared from an antigen source so as to obtain an accurate measurement. After some period of time (hours, days, weeks, months or years), replicate measurement of the NPAR are recorded for a second liquid chromatography sample prepared from the same antigen source so as to obtain accurate measurements. Preferably, liquid chromatography samples are made within 1-2 days of use. Because the antigen peaks correlate directly to antigen stability, the NPAR values for the two liquid chromatography samples can be used to determine whether the antigen source is stable. A stable NPAR value over time indicates an antigen source that has not degraded. In contrast, decreasing NPAR values over time indicates that the antigen in the antigen source is degrading.

This liquid chromatography method for following a vaccine's stability can be used, for example, to follow the stability of newly produced batches (or lots) of antigen or vaccine or of the reference vaccine.

The present invention also provides a method by which the potency of antigen from some antigen source can be measured using liquid chromatography. It is important to measure antigen potency whether dealing with an unfinished harvested bulk of antigen from a culture batch or with a finished vaccine. In the former case, it is preferable to know the antigen potency of the bulk material prior to committing more resources (e.g., material, personnel or equipment time) to that material, or to calculate the amount necessary to produce final product of desired strength or potency. In the latter case, a finished vaccine product cannot be released for distribution or sale unless it is shown to have sufficient potency.

The liquid chromatography potency assay made possible by Applicants' present invention compares liquid chromatography measurements of samples prepared from a given antigen source to liquid chromatography measurements obtained from a reference source. A freshly batched vaccine's potency is typically measured against that of a reference vaccine. A reference vaccine is a vaccine that has been shown directly or indirectly to be efficacious or immunogenic in humans or animals. Comparative potency measurements can also be made between antigen not yet in final vaccine product and the reference vaccine. Alternatively, antigen not yet in final vaccine product can be compared against reference antigen (or, master antigen standards) instead of the reference vaccine. “Reference antigen” can refer to a source of antigen at any stage in the production process known to have a quantity or quality of antigen at levels sufficient for further processing towards final vaccine production. The “reference source” can be the reference vaccine or the reference antigen.

As used herein, a reference vaccine refers to a master reference or a working reference. A master reference is a reference whose potency is correlated, directly or indirectly, to host animal immunogenicity. The master reference may be used as the working reference in in vitro tests for relative potency. The master reference may also be used to establish the relative potency of a serial of product used in requalification studies and to establish the relative potency of working references. Nonlimiting examples of the master reference include: (1) a completed serial of vaccine or bacterin; (2) a purified preparation of a protective immunogen or antigen; or (3) a nonadjuvanted harvested culture of microorganisms. A working reference is the reference preparation that is used in the in vitro test for the release of serials of product. Nonlimiting examples of working references include: (1) master references; or (2) serials of product that have been prepared and qualified, in a manner acceptable to Animal and Plant Health Inspection Service for use as reference preparations.

Reference vaccines typically lose their certification as “reference vaccines” after a certain number of years and consequently need to be reestablished as “reference vaccines.” Reestablishing (or, requalifying) a reference vaccine can be done, for example, by demonstrating efficacy. As discussed herein, however, the present invention provides another method by which a reference vaccine can be requalified as such.

As in the case above with stability measurements, an internal standard is employed where an external standard having a known quantity or concentration is not available for making relative potency measurements. A relative potency measurement provides the potency of antigen of one source of antigen relative to the potency of antigen in a reference source. Because the antigen peaks correlate directly with the amount of antigen present in the antigen source, the potency of a vaccine batch can be measured by comparing the NPAR of a liquid chromatography sample prepared from an antigen source to the NPAR of a liquid chromatography sample prepared from the reference source. Antigen sources having the same or greater NPAR value than that of the reference sources have the requisite level of potency for further processing (as in the case of unfinished product) or for sale/release (as in the case of finished product).

Where an external standard having a quantified amount of antigen is available, the measurements of a liquid chromatography sample prepared from any source of antigen can be used to quantify the amount of antigen without the use of an internal standard. Such quantification affords measurements of the potency or the stability of the source of antigen. In such a case, a regression analysis using the external standard at varying concentrations can be performed to find a graphical curve that correlates liquid chromatography peak area for the antigen to the concentration (or quantity) of the antigen. After the regression analysis has been performed, the concentration (or quantity) of antigen present in any source of antigen can be determined by measuring the liquid chromatography peak areas for the antigen present in a liquid chromatography sample prepared from that source of antigen. The actual value of the concentration (or quantity) of antigen present in the sample correlates to potency. Changes in the actual value of the concentration (or quantity) of antigen present in the sample correlate to stability. As above, liquid chromatography samples are preferably prepared within about 1-2 days of use.

Liquid chromatography samples can be prepared from antigen sources by using techniques well know in the protein chemistry arts. Antigen sources can be subjected to physical (e.g., centrifugation, sonication, etc.) or chemical treatment (salt-induced precipitation, changes in pH) to prepare the liquid chromatography samples. Preferably, such treatment is performed so as not to cause any degradation of antigen within the antigen source. Sonication can be performed, for example, in a water bath to prevent heating and subsequent degradation of the sample.

A variety of internal standards can be used. Preferably, the internal standard is stable and does not undergo any changes from the time a liquid chromatography sample is prepared to the time the sample is inserted into a liquid chromatography apparatus. The internal standard also preferably elutes out of the column at a unique time and apart from any part of the antigen peak (i.e., does not co-elute with other materials).

The following examples are provided for illustrative purposes only, and are in no way intended to limit the scope of the present invention.

### EXAMPLES

### Example 1

### Neospora caninum Vaccine

The following describes a reverse-phase high performance liquid chromatography (HPLC) method developed to quantitate the amount of antigen in an inactivated Neospora caninum vaccine. The method utilizes gradient elution on a C-18 column with UV detection at 210 nm. The amount of antigen is quantitated using an internal standard to determine the relative amount of antigen present in the vaccine. The method was validated by performing specificity, linearity, accuracy, and precision experiments. The results obtained by the HPLC assay was demonstrated to correlate with the results obtained from the ELISA relative potency assay.

### 1.1 Fenbendazole (FBZ) Internal Standard Stock Solution Preparation

Because no external standard is available for the quantization of the antigen protein, an internal standard was used to quantitate the amount of antigen protein. Fenbendazole (FBZ) internal standard stock solution was prepared by accurately weighing 50 mg of fenbendazole into a 50 mL volumetric flask. The fenbendazole was dissolved in 5 mL of dimethylformamide (DMF, HPLC grade). The FBZ/DMF solution was diluted to a volume of 50 mL with methanol (HPLC grade) and mixed well.

### 1.2 HPLC Sample Preparation

A sample of Neospora caninum vaccine (Intervet Inc., Millsboro, Del.) was magnetically stirred. While stirring, 4.0-mL of the vaccine was pipetted into a 15 mL centrifuge tube followed by 2.0 mL of methanol (HPLC grade). After capping the centrifuge tube and mixing the contents well, the mixture was sonicated for 10 minutes in a water bath kept at about 20-25° C. followed by centrifugation at 3000 rpm for 10 minutes. 100 μL of fenbendazole internal standard stock solution was added into a 5 mL volumetric flask and diluted with the sample supernatant liquid to a total volume of 5 mL, and mixed well.

### 1.3 HPLC Analysis Procedure

HPLC was conducted on an HPLC apparatus fitted with an Agilent 1100 HPLC pump, Agilent 1100 HPLC Autosampler, Agilent 1100 HPLC UV Detector, and an Agilent ChemStation HPLC Data Acquisition System. An Agilent Zorbax Eclipse C18 HPLC column was used for sample separation (150×4.6 mm i.d., 5 μm average particle size).

The column was maintained at 30° C. and pre-equilibrated by alternatively injecting the column with 100 μL of sample followed by a blank injection of Mobile Phase B (HPLC grade acetonitrile with 1 mL/L Trifluoroacetic acid (TFA, HPLC grade)). Samples were run as pre-equilibration samples until five replicate sample injections yielded a % Relative Standard Deviation (% RSD) of the Peak Area Ratios (PARs, Neospora antigen/fenbendazole) of <3%. Antigen is detected by UV absorption at 210 nm. Each injection of a sample was followed by an injection (nm) of Mobile Phase B, in order to prevent sample carryover. When a new column is used, multiple equilibration injections were found to be necessary.

After injecting 100 μL of sample or blank onto the column (whether a pre-equilibration sample or a sample injected after the column was equilibrated), elution of sample or blank was achieved with a flow of 1 mL/minute of a gradient of mobile phases (A: purified water (ASTM Type I or equivalent) with 1 mL/L trifluoroacetic acid (TFA, HPLC grade); B: HPLC grade acetonitrile with 1 mL/L TFA) according to Table 1. The trifluoroacetic acid is added to the mobile phase to lower the pH and to serve as an ion-pair reagent.

TABLE 1
Elution Gradient for Neospora caninum

| Time (minutes) | % Mobile Phase A | % Mobile Phase B |
|---|---|---|
| 0 | 70 | 30 |
| 2 | 55 | 45 |
| 10 | 50 | 50 |
| 15 | 10 | 90 |
| 20 | 10 | 90 |
| 21 | 70 | 30 |
| 25 | 70 | 30 |

The retention time of the Neospora caninum antigen is around 3.7 minutes. The retention time of the fenbendazole internal standard is around 5.0 minutes. Retention of the antigen peak may be adjusted by changing the initial rate of the Mobile Phase B (e.g., faster rate shortens the retention time of the antigen peak). Retention of the fenbendazole peak may be adjusted by changing the concentration of TFA in the mobile phase (e.g., higher concentrations of TFA increases the retention time of the FBZ peak).

Quantization of the antigen protein peak is accomplished by the use of an internal standard (fenbendazole) and the results may be reported as a peak area ratio or concentration as fenbendazole equivalents. This was necessary as no purified external standard was available. A fenbendazole-weight normalized peak area ratio is calculated using the following formula:

Peak Area Ratio=[(Peak Area of Neospora caninum antigen)/(Peak Area of FBZ)]×(wt. of FBZ in mg/50)

The “wt. of FBZ in mg” is the weight of FBZ measured in mg that was used to prepare the HPLC sample. Alternatively, quantization of antigen could be reported in concentration units of fenbendazole equivalents using the following formula:

mg/mL FBZ Equivalents=[(Peak Area Ratio×1 mg/mL)×(0.1 mL)]/(5 mL×0.65)

### 1.4 HPLC Identification of Antigen and Fenbendazole Internal Standard

To determine which peak was the peak associated with the antigen, a preliminary gradient HPLC method was used to separate most of the components found in the Neospora caninum vaccine. Fractions of each peak or peak group were collected for ELISA or polyacrylamide gel electrophoretic (PAGE) assay. Only one fraction was found to show a response for the ELISA-positive antigen.

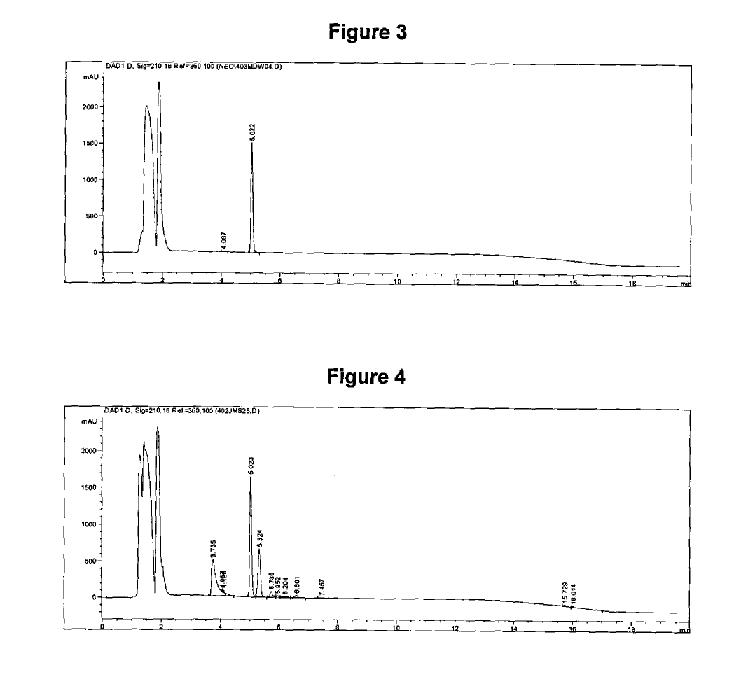

HPLC conditions were then adjusted as described above in Table 1 to optimize the separation and resolution of this peak. A representative chromatogram of the Neospora caninum vaccine using the final HPLC conditions (but without FBZ standard) is shown in FIG. 1. A representative HPLC chromatogram of the isolated HPLC fraction using the elution gradient of Table 1 showing response using the ELISA assay is shown in FIG. 2. Hence, the peak of interest elutes at approximately 3.7 minutes using the proposed HPLC conditions. A representative chromatogram of FBZ internal standard obtained using the above described final HPLC conditions is shown in FIG. 3. Hence, the FBZ internal standard elutes at approximately 5 minutes. FIG. 4 shows a representative chromatogram of an N. caninum vaccine sample prepared according to the method described above, with FBZ added and run through the HPLC column using the column and gradient described above. The Agilent ChemStation HPLC Data Acquisition System provides the area under the curve values for the antigen peak and the FBZ peak respectively around 3.7 and 5 minutes.

These chromatograms demonstrate that the peaks of interest associated with the Neospora caninum antigen and the internal standard (fenbendazole) are well resolved from the peaks associated with the other ingredients in the vaccine.

Therefore, the proposed method is specific for its intended use.

### 1.5 Linear Correlation Between HPLC Peak Area Ratios and Antigen Concentration

A linearity study was conducted using various concentrations of Neospora caninum antigen. Solutions were prepared at antigen concentrations of 1%, 2%, 3%, 4%, and 5% (v/v) in water, which corresponded respectively to about 40-200% of the concentration of the antigen as it occurs in the vaccine. The solutions were prepared and analyzed by HPLC according to the proposed method.

Linear regression analysis of detector response as peak area ratio vs. antigen concentration was conducted using the Linear Regression function in Microsoft® Office Excel 2003 SP2 in order to generate the following statistics: product-moment correlation coefficient (r), y-intercept, slope, and upper and lower 95% confidence intervals of the y-intercept.

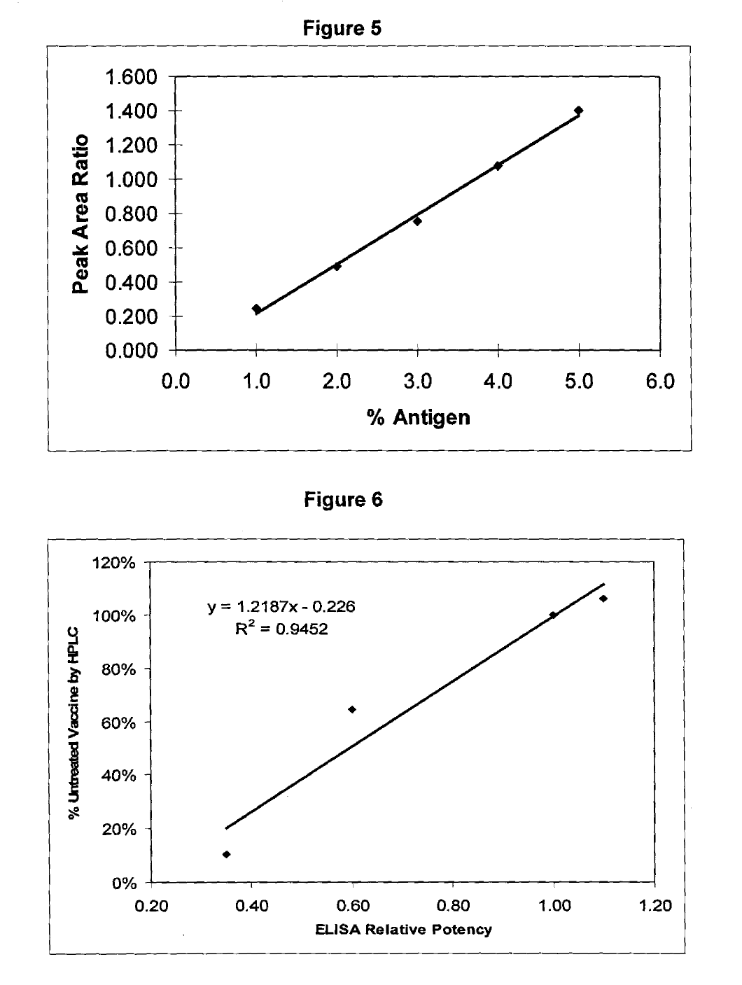

The data are summarized in Table 2 and FIG. 5. The correlation coefficient (r) was determined to be 0.998. The upper and lower 95% confidence intervals bracketed zero, indicating that the y-intercept was not significantly different than zero. Therefore, the HPLC method described herein provides a direct linear correlation between the antigen concentration and the peak area ratio.

TABLE 2
Results Obtained for a Linearity Study of the Detector Response
Measured as Peak Area Ratio vs. the Concentration of Neospora caninum
Antigen as Obtained Applying the Chromatographic Conditions Specified
in the Proposed Method

| % Neospora Concentrated | | Predicted Peak |
|---|---|---|
| Antigen | Peak Area Ratio¹ | Area Ratio² |
| 1.0% | 0.250 | 0.216 |
| 2.0% | 0.489 | 0.505 |
| 3.0% | 0.753 | 0.794 |
| 4.0% | 1.080 | 1.083 |
| 5.0% | 1.398 | 1.371 |

Regression Statistics

| | |
|---|---|
| Correlation Coefficient (R): | 0.998 |
| Slope: | 0.289 μV · s |
| Y-Intercept: | −0.072 μV · s |
| Y-Intercept Lower 95% Confidence Limit: | −0.190 μV · s |
| Y-Intercept Upper 95% Confidence Limit: | 0.046 μV · s |

¹Peak area ratio was measured as mean (n = 2) samples by dividing the peak area of the Neospora caninum antigen peak by the peak area of the Fenbendazole internal standard.
²Predicted Peak Area Ratios are the ratio values that fall on the regression curve for the respective % Neospora Concentrated Antigen values.

### 1.6 Linear Correlation Between HPLC Peak Area Ratios and Antigen Potency as Measured by ELISA

The HPLC assay method was evaluated for its ability to accurately detect relative potency by correlating peak area ratios to relative potency values as determined using the standard ELISA assay. This study employed samples of Neospora caninum vaccine that had previously been stressed to induce degradation. Samples were stressed using heat, acid, base, sonication, and freeze/thaw cycles. A non-stressed sample of the vaccine was also analyzed for comparison purposes.

The results of the accuracy study are summarized in Table 3. A plot of the correlation between the proposed HPLC method and the ELISA potency assay is depicted in FIG. 6. The proposed method was able to discriminate between the stressed samples and was shown to have reasonable correlation with the ELISA potency assay (r²=0.95). Therefore, the proposed method was deemed to be sufficiently accurate for its intended use.

TABLE 3
Results of Accuracy Study and Comparison of Analysis of Stressed
Samples Using the Proposed Method and ELISA Assay

| | % of Antigen versus Non- | |
|---|---|---|
| | Stressed Vaccine Using | Relative Potency |
| Stressed Condition | Proposed Method | by ELISA |
| Base | 0% | NA¹ |
| Acid | 43% | NA¹ |
| Base, Neutralized | 0% | NA¹ |
| Boiled for 30 minutes | 43% | NA¹ |
| Sonicated for 30 minutes | 11% | 0.35 |
| Acid, Neutralized | 65% | 0.60 |
| Freeze/Thaw 6 cycles | 106% | 1.10 |
| Non-Stressed | 100% | 1.00 |

Correlation Regression Statistics

| | |
|---|---|
| Correlation Coefficient (R): | 0.95 |
| Slope: | 1.22 |
| Y-Intercept: | −0.23 |
| p-Value | 0.03 |

¹Relative potency could not be calculated due to insufficient data points, incompatible pH condition, or total degradation of sample.

### 1.7 Precision of the HPLC Method

A precision study was conducted by analyzing a batch of Neospora caninum vaccine according to the proposed method. Variance in the system (system precision) was determined by injecting five replicates of the same sample solution onto the HPLC. Variance in the preparation of sample from a particular batch of vaccine (intra-assay precision) was determined by preparing and analyzing six replicates of the same batch of vaccine. Variance amongst operators (intermediate precision) was determined by two analysts conducting the intra-assay precision study on separate days and different HPLC columns.

The results of the system precision experiments are shown in Table 4. The % RSD values for replicate injections of the same sample solutions were 1.1% and 2.7% for the two analysts (n=5).

TABLE 4
Results Obtained for System Precision from Five Replicate Sample
Solution Injections Analyzed as Specified in the Proposed Method

Peak Area Ratio

| Injection | Analyst 1 | Analyst 2 |
|---|---|---|
| 1 | 0.851 | 0.798 |
| 2 | 0.867 | 0.771 |
| 3 | 0.876 | 0.810 |
| 4 | 0.876 | 0.787 |
| 5 | 0.866 | 0.828 |
| Mean: | 0.87 | 0.80 |
| % RSD: | 1.1% | 2.7% |

The results of the intra-assay and intermediate precision experiments are shown in Table 5. The % RSD values for replicated sample preparations of the same batch of vaccine were 2.8% and 2.5% for Analyst 1 and Analyst 2, respectively (n=6). The % RSD for all sample preparations was 5.2% (n=12).

TABLE 5
Results Obtained for Intra-Assay and Intermediate Precision from
Six Replicate Neospora caninum Vaccine Sample Preparations
Analyzed as Specified in the Proposed Method

μg/mL FBZ Equivalents

| Injection | Analyst 1 | Analyst 2 |
|---|---|---|
| 1 | 26.7 | 25.8 |
| 2 | 26.7 | 24.1 |
| 3 | 27.1 | 25.1 |
| 4 | 28.7 | 24.8 |
| 5 | 27.0 | 25.7 |
| 6 | 27.6 | 24.8 |
| Mean: | 27 | 25 |
| % RSD: | 2.8% | 2.5% |

Grand Mean = 26 μg/mL
% RSD = 5.2%

These data demonstrate that the proposed method has sufficient system precision, intra-assay precision, and intermediate precision for its intended use.

### 1.8 Internal Standard Solution Stability

The internal standard solution is stable over the course of time it is used. Although vaccine samples may be frozen or stored at cold temperatures from days to years, HPLC samples, as well as the internal standard solution, are prepared and used preferably within a week, and most preferably within 1-2 days. The internal standard is stable over these periods for purposes of HPLC analysis described herein.

### Example 2

### Mycoplasma hyopneumoniae Vaccine

A reverse-phase high performance liquid chromatography (HPLC) method was developed and validated to quantitate the amount of antigen in Myco Silencer® Once (Intervet Inc., Millsboro, Del.), an inactivated Mycoplasma hyopneumoniae vaccine. The method utilizes gradient elution on a C-18 HPLC column with UV detection at 210 nm. The amount of antigen is quantitated using an internal standard to determine the relative amount of antigen present in the vaccine. The method was validated by performing specificity, linearity, accuracy, and precision experiments. The results obtained by the HPLC assay was demonstrated to correlate with the results obtained from the ELISA relative potency assay.

### 2.1 Dipropyl Phthalate (DPP) Internal Standard Solution Preparation

A dipropyl phthalate (DPP) internal standard stock solution was prepared by accurately weighing 50 mg of dipropyl phthalate into a 50 mL volumetric flask. The DPP was dissolved and diluted to a volume of 50 mL total with methanol and mixed well. The approximate concentration of this solution is 1 mg/mL. Dipropyl Phthalate Working Standard Solution was made by transferring a 10.0-mL aliquot of the DPP internal standard stock solution into a 50-mL volumetric flask, and diluting it to a total volume of 50 mL with water and mixed well. The approximate concentration of the working solution is 0.2 mg/mL.

### 2.2 HPLC Sample Preparation

Mycoplasma hyopneumoniae vaccine (Intervet Inc., Millsboro, Del.) was magnetically stirred. While stirring, 2.0-mL of the vaccine was pipetted into a 15-mL centrifuge tube. The tube was then centrifuged at approximately 15,000 rpm (ca. 29,000×g) for 30 minutes at 4° C. The centrifugation separates the emulsion into two layers. Following centrifugation, the aqueous (lower) layer was carefully pipetted into a separate centrifuge tube.

The following were pipetted into a 5-mL volumetric flask: 2-mL of tris buffer solution (12.1 g of tris base (USP grade) dissolved in 1 L of purified water (ASTM Type I), adjusted to pH of 6.8 with concentrated HPLC grade phosphoric acid), 1.0-mL of the post-centrifugation aqueous sample solution from above, and 1.0-mL of the DPP working standard solution from above. This mixture was diluted to a total volume of 5-mL with purified water (ASTM Type I) and mixed well.

### 2.3 HPLC Analysis Procedure

HPLC was conducted on the same HPLC apparatus as described above in section 1.3, with the column also maintained at 30° C. and pre-equilibrated by alternatively injecting the column with 50 μL of sample followed by a blank injection of methanol/water (1/1, v/v). Samples were run as pre-equilibration samples until five replicate sample injections yielded a % Relative Standard Deviation (% RSD) of the Peak Area Ratios (PARs, Mycoplasma hyopneumoniae antigen/DPP) of <3%. Antigen is detected by UV absorption at 210 nm. Each injection of a sample was followed by an injection (run) of a blank of methanol/water (1/1, v/v) in order to prevent sample carryover. When a new column is used, multiple equilibration injections were found to be necessary.

After injecting each 50 μL of sample or blank onto the column (whether a pre-equilibration sample or a sample injected after the column was equilibrated), elution of sample or blank was achieved with a flow of 1 mL/minute of a gradient of mobile phases (A: purified water (ASTM Type I or equivalent) with 1 mL/L trifluoroacetic acid (TFA, HPLC grade); B: HPLC grade acetonitrile with 1 mL/L HPLC grade TFA) according to Table 6. The trifluoroacetic acid is added to the mobile phase to lower the pH and to serve as an ion-pair reagent.

TABLE 6
Elution Gradient for Mycoplasma hyopneumoniae

| Time (minutes) | % Mobile Phase A | % Mobile Phase B |
|---|---|---|
| 0 | 70 | 30 |
| 5 | 50 | 50 |
| 10 | 50 | 50 |
| 15 | 5 | 95 |
| 16 | 70 | 30 |
| 25 | 70 | 30 |

The retention time of the ELISA-positive Mycoplasma hyopneumoniae antigen is around 5 minutes. The retention time of the DPP internal standard is around 15 minutes. Retention of the antigen peak may be adjusted by changing the initial rate of the Mobile Phase B (e.g., faster rate shortens the retention time of the antigen peak).

Quantization of the antigen protein peak is accomplished by the use of an internal standard (DPP) and the results may be reported as a peak area ratio or concentration as DPP equivalents. This was necessary as no purified external standard was available. A DPP-weight normalized peak area ratio is calculated using the following formula:

Peak Area Ratio=[(Peak Area of Mycoplasma hyopneumoniae antigen)/(Peak Area of DPP)]×(wt. of DPP in mg/50)

The “wt. of DPP in mg” is the weight of DPP measured in mg that was used to prepare the HPLC sample. Alternatively, quantization of antigen could be reported in concentration units of fenbendazole equivalents using the following formula:

mg/mL DPP Equivalents=Peak Area Ratio×0.2 mg/mL

### 2.4 HPLC Identification of Antigen and DPP Internal Standard

To determine which peak was the peak associated with the antigen, a preliminary gradient HPLC method was used to separate most of the components found in the Mycoplasma hyopneumoniae vaccine. Fractions of each peak or peak group were collected for ELISA or polyacrylamide gel electrophoretic (PAGE) assay. Only one fraction was found to show a response for the ELISA-positive antigen.

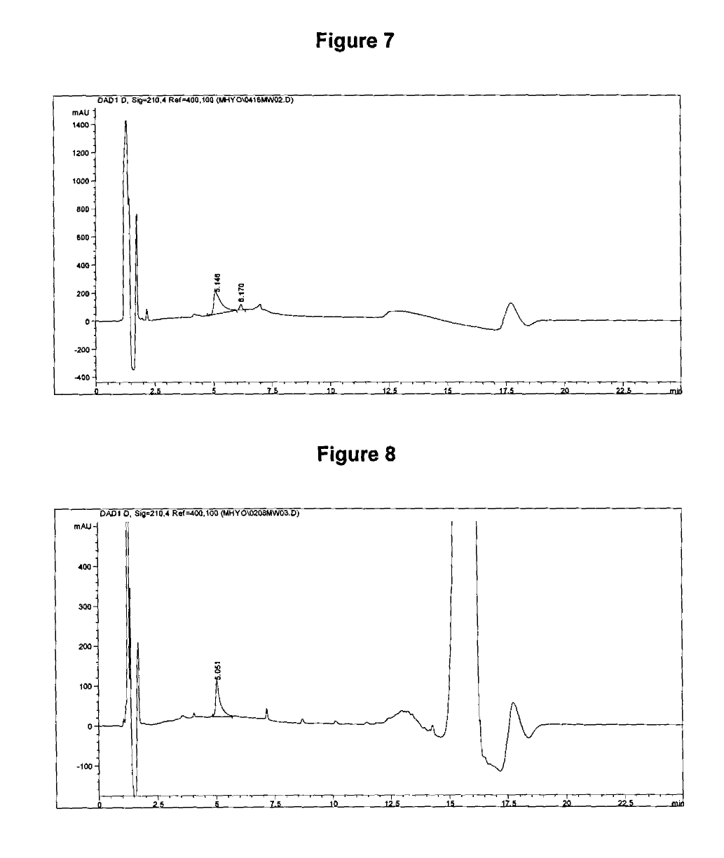

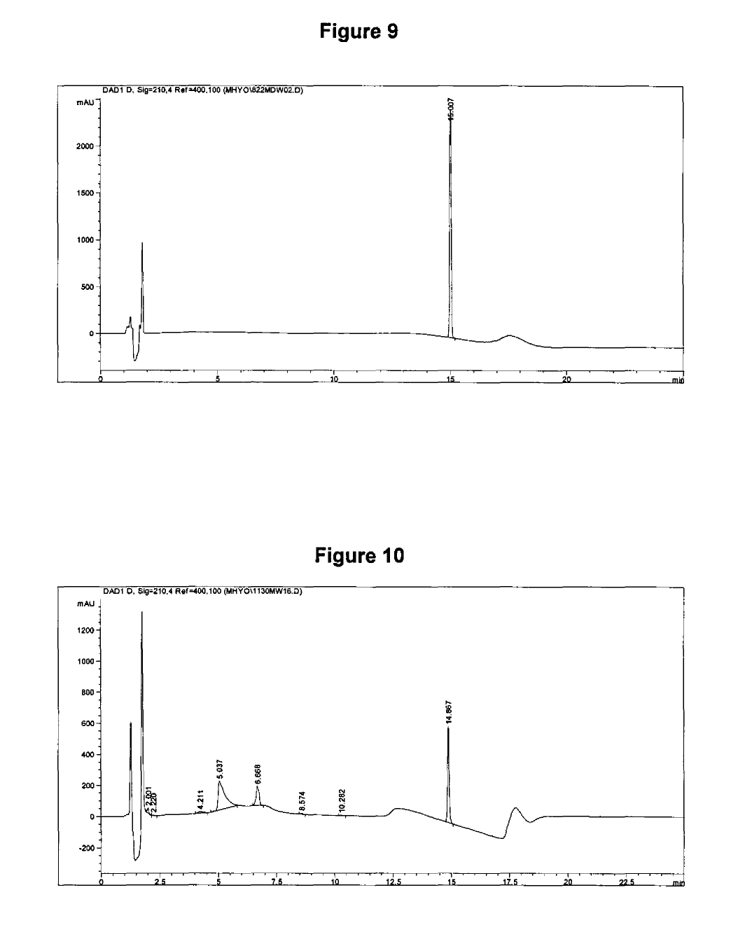

HPLC conditions were then adjusted as described above to optimize the separation and resolution of this peak. Under these conditions, the peak of interest was found to elute at approximately 5 minutes. A representative chromatogram of the Mycoplasma hyopneumoniae vaccine using the final HPLC conditions (but without DPP standard) is shown in FIG. 7. Another chromatogram taken under identical HPLC conditions of a sample of antigenic material solubilized from an isolated electrophoretic polyacrylamide gel electrophoresis band gives rise to a peak at the same time (FIG. 8). The material solubilized from the gel band is known to represent Mycoplasma hyopneumoniae p44 antigen.

No external standard is available for the quantization of the antigen protein. Accordingly, an internal standard was used to quantitate the amount of antigen in the vaccine samples. Because the vaccine contains a large amount of proteinaceous material that causes peak tailing and elutes after the antigen protein, a internal standard was selected that elutes after all the proteinaceous material. Dipropyl phthalate (DPP) was chosen since it was commercially readily available and elutes after the proteinaceous material in the chromatogram, as shown in FIGS. 9 and 10. FIG. 9 shows an HPLC chromatogram of DPP using the HPLC apparatus and mobile phase gradient described in sections 2.1-2.3 above. FIG. 10 shows an HPLC chromatogram of Mycoplasma hyopneumoniae vaccine prepared as an HPLC sample using the HPLC apparatus and mobile phase gradient as described in sections 2.1-2.3 above.

These chromatograms demonstrate that the peak of interest associated with the Mycoplasma hyopneumoniae antigen and the internal standard (DPP) are adequately resolved from the peaks associated with the other ingredients in the vaccine. Therefore, the proposed method is specific for its intended use.

### 2.5 Linear Correlation Between HPLC Peak Area Ratios and Antigen Concentration

A linearity study was conducted using Mycoplasma hyopneumoniae concentrated antigen. Solutions were prepared at antigen concentrations of 1%, 3%, 6%, 9%, 12%, 15%, 18%, and 24% (v/v) in water (8-200% of target concentration). The solutions were prepared and analyzed by HPLC according to the proposed method.

Linear regression analysis of detector response as peak area ratio vs. antigen concentration was conducted using the Linear Regression function in Microsoft® Office Excel 2003 SP2 in order to generate the following statistics: product-moment correlation coefficient (r), y-intercept, slope, and upper and lower 95% confidence intervals of the y-intercept.

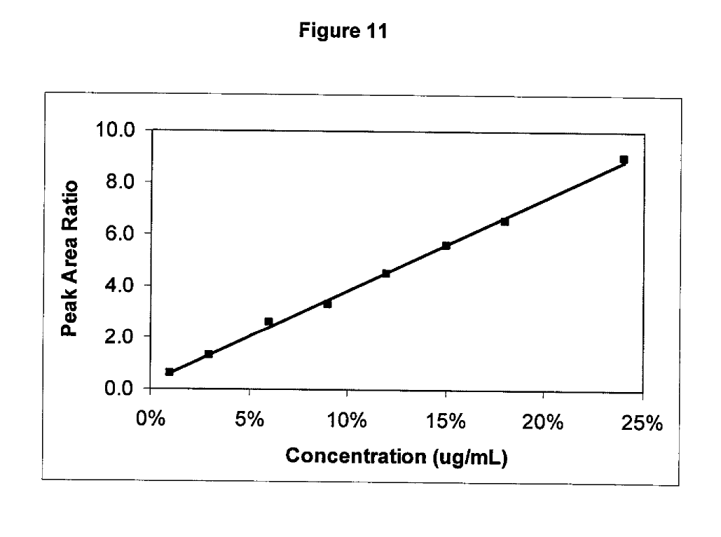

The data are summarized in Table 7 and FIG. 11. The correlation coefficient (r) was determined to be 0.9990. Therefore, the proposed method was deemed to be sufficiently linear for its intended use.

TABLE 7
Results Obtained for a Linearity Study of the Detector Response
Measured as Peak Area Ratio vs. the Concentration of Mycoplasma
hyopneumoniae Antigen as Obtained Applying the Chromatographic
Conditions Specified in the Proposed Method

| % M. hyo | | Predicted Peak |
|---|---|---|
| Concentrated Antigen | Peak Area Ratio¹ | Area Ratio |
| 1% | 0.5904 | 0.5801 |
| 3% | 1.2759 | 1.2997 |
| 6% | 2.5930 | 2.3791 |
| 9% | 3.3190 | 3.4585 |
| 12% | 4.4855 | 4.5379 |
| 15% | 5.6147 | 5.6173 |
| 18% | 6.5563 | 6.6967 |
| 24% | 8.9899 | 8.8555 |

Regression Statistics

| | |
|---|---|
| Correlation Coefficient (r): | 0.9990 |
| Slope: | 0.360 μV · s/% M. hyo |
| Y-Intercept: | 0.220 μV · s |
| Y-Intercept Lower 95% Confidence Limit: | 0.012 μV · s |
| Y-Intercept Upper 95% Confidence Limit: | 0.428 μV · s |

¹Peak area ratio was measured as mean (n = 2) samples by dividing the peak area of the Mycoplasma hyopneumoniae antigen peak by the peak area of the DPP internal standard.

### 2.6 Correlation Between HPLC Peak Area Ratios and Antigen Potency as Measured by ELISA

### 2.6.1 Correlation Using Degraded Samples

An accuracy study was conducted by analyzing samples according to the proposed method of the Mycoplasma hyopneumoniae vaccine that had previously been stressed to induce degradation. A non-stressed sample of the vaccine was also analyzed for comparison purposes. These samples had previously been analyzed by ELISA and were shown to have degraded. Samples were stressed by boiling and with the addition of various concentrations of Proteinase K. A non-stressed sample of the vaccine was also analyzed for comparison purposes.

The results obtained during the degradation study are summarized in Table 8. The results demonstrated that the proposed method could detect changes in the Mycoplasma hyopneumoniae vaccine as it is degraded.

TABLE 8
Results of Degradation Study

| Samples Degraded with | | | |
|---|---|---|---|
| ProteinaseK | | Samples Degraded by Boiling | |
| | % of Antigen vs. | | % of Antigen vs. |
| | Non-Stressed | | Non-Stressed |
| | Vaccine Using | | Vaccine Using |
| Sample | Proposed Method | Sample | Proposed Method |
| Untreated | 100% | Untreated | 100% |
| PK 1:16 | 33% | 0.5 Minute Boil | 62% |
| Dilution | | | |
| PK 1:8 | 32% | 1 Minute Boil | 65% |
| Dilution | | | |
| PK 1:4 | 27% | 2 Minute Boil | 53% |
| Dilution | | | |
| PK 1:2 | 18% | 5 Minute Boil | 4% |
| Dilution | | | |
| PK | 12% | 10 Minute Boil | 3% |
| concentrated | | | |

### 2.6.2 Correlation Using Spiked Samples

A solution based on the vaccine but lacking the antigen was made to test the correlation between peak area ratios and relative potency as determined using an ELISA assay. The solutions were prepared to contain 0%, 3.75%, 7.5% and 15% of Mycoplasma hyopneumoniae concentrated antigen. The samples were analyzed using the HPLC method described by Example 2 and independently via ELISA.

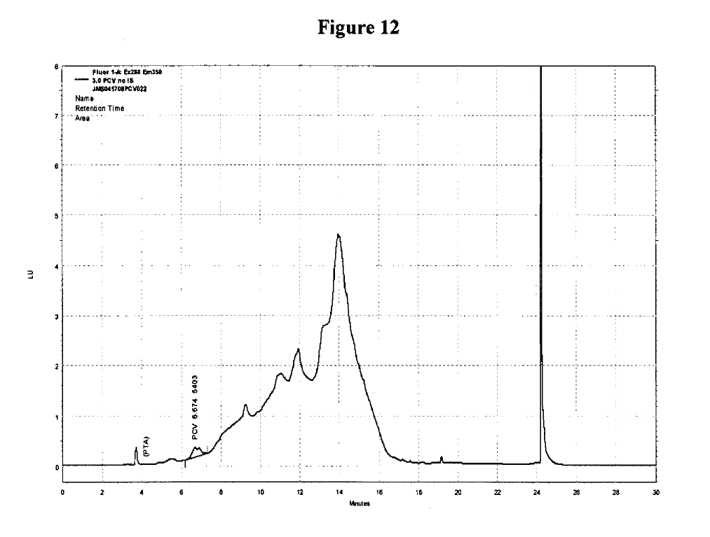

The results are presented in Table 9. A representative chromatogram of the saline-buffered solution with antigen is shown in FIG. 12. The results showed relatively good correlation (r=0.996) with the ELISA results and demonstrated that differences in the concentration of Mycoplasma hyopneumoniae antigen in the vaccine matrix could be accurately determined.

TABLE 9
Results Obtained for the Accuracy Study Using Spiked Placebo
Samples Analyzed as Specified in the Proposed Method

| | mg/mL DPP | Relative Potency | Relative Potency |
|---|---|---|---|
| Sample | Equivalents | From HPLC | From ELISA |
| Placebo | ND | ND | ND |
| 3.75% Ag | 0.439 | 0.48 | 0.44 |
| 7.5% Ag | 0.828 | 0.90 | 0.92 |
| 15.0% Ag | 1.444 | 1.57 | 2.01 |

Correlation Coefficient (r) = 0.996;
ND = None Detected

The data for sections 2.6.1 and 2.6.2 demonstrate that the proposed method accurately correlates peak area ratios ascertained from the HPLC method described herein to vaccine potency as measured by ELISA.

### 2.7 Precision of the HPLC Method

A precision study was conducted by analyzing a batch of Mycoplasma hyopneumoniae vaccine according to the proposed method. Variance in the system (system precision) was determined by injecting at least six replicates of the same sample solution onto the HPLC. Variance in the preparation of sample from a particular batch of vaccine (intra-assay precision) was determined by preparing and analyzing six replicates from the batch of the vaccine. Variance amongst operators (intermediate precision) was determined by two analysts conducting the intra-assay precision study on separate days and different HPLC columns.

The results of the system precision experiments are shown in Table 10. The % RSD values for replicate injections of the same sample solutions were 0.73% and 1.73% for the two analysts (n=6).

TABLE 10
Results Obtained for System Precision from Five Replicate Sample
Solution Injections Analyzed as Specified in the Proposed Method

Peak Area Ratio

| Injection | Analyst 1 | Analyst 2 |
|---|---|---|
| 1 | 1.535 | 1.554 |
| 2 | 1.558 | 1.563 |
| 3 | 1.537 | 1.537 |
| 4 | 1.534 | 1.562 |
| 4 | 1.525 | 1.534 |
| 6 | 1.540 | 1.492 |
| Mean: | 1.54 | 1.54 |
| % RSD: | 0.73% | 1.73% |

The results of the intra-assay and intermediate precision experiments are shown in Table 11. The % RSD values for replicated sample preparations of the same batch of vaccine were 3.3% and 2.3% for Analyst 1 and Analyst 2, respectively (n=6). The % RSD for all sample preparations was 4.7% (n=12).

TABLE 11
Results Obtained for Intra-Assay and Intermediate Precision
from Six Replicate Mycoplasma hyopneumoniae Vaccine Sample
Preparations Analyzed as Specified in the Proposed Method

mg/mL DPP Equivalents

| Injection | Analyst 1 | Analyst 2 |
|---|---|---|
| 1 | 0.314 | 0.313 |
| 2 | 0.322 | 0.297 |
| 3 | 0.318 | 0.298 |
| 4 | 0.320 | 0.306 |
| 5 | 0.332 | 0.295 |
| 6 | 0.343 | 0.301 |
| Mean: | 0.325 | 0.301 |
| % RSD: | 3.3% | 2.3% |

Grand Mean = 0.31 mg/mL
% RSD = 4.7%

These data demonstrate that the proposed method has sufficient system precision, intra-assay precision, and intermediate precision for its intended use.

### 2.8 Internal Standard Solution Stability

The standard solution stability was evaluated at ambient conditions. Standard solutions were prepared and analyzed according to the proposed method after 2 and 8 days of storage at ambient conditions. The standard solution was shown to be stable (101% of initial concentration) after 8 days of storage. Although vaccine samples may be frozen or stored at cold temperatures from days to years, HPLC samples, as well as the internal standard solution, are prepared and used preferably within a week, and most preferably within 1-2 days. The internal standard is stable over these periods for purposes of HPLC analysis described herein.

### 2.9: Column Wash Procedure

The HPLC column should be washed periodically (recommended after every HPLC run) to avoid the buildup of adjuvant and protein residues on the column. The buildup of these residues on the column can cause peak shape deterioration and change the recovery of the antigen from the HPLC column.

To wash the column, flush the column for 30 minutes with Mobile Phase A/Mobile Phase B (5/95, v/v) at 50° C. and 2 mL/minute to remove any adjuvant residues. Then, while the column is maintained at 50° C., inject 100 μL, of tris buffer solution using the elution gradient of Table 12 at a flow rate of 1 mL/minute (Mobile Phase A: purified water (ASTM type 1) with 1 mL/L Trifluoroacetic acid (TFA, HPLC grade); Mobile Phase B: HPLC grade Acetonitrile with 1 mL/L HPLC grade TFA). The column wash procedure is repeated as necessary.

TABLE 12
Elution Gradient for Washing Column of Example 2

| Time | | % Mobile |
|---|---|---|
| (minutes) | % Mobile Phase A | Phase B |
| 0 | 70 | 30 |
| 2 | 40 | 60 |
| 4 | 70 | 30 |
| 6 | 40 | 60 |
| 8 | 70 | 30 |
| 10 | 40 | 60 |
| 12 | 70 | 30 |
| 14 | 40 | 60 |
| 16 | 70 | 30 |
| 18 | 40 | 60 |
| 20 | 70 | 30 |
| 22 | 40 | 60 |
| 24 | 70 | 30 |
| 26 | 40 | 60 |
| 28 | 70 | 30 |
| 30 | 40 | 60 |

### Example 3

### Porcine Circovirus Antigen in a Bivalent Vaccine

The porcine circovirus (PCV) antigen in a bivalent PCV type 2-Killed Baculovirus Vector-Mycoplasma Hyopneumoniae Bacterin (combination of Circumvent® PCV vaccine and Myco Silencer® Once, Intervet Inc., Millsboro, Del.) was isolated by precipitation, solubilized, and analyzed by reverse-phase high performance liquid chromatography (HPLC). The amount of PCV antigen present in the test article was quantitated using an internal standard to obtain a relative concentration of antigen. The result was expressed as the Normalized Peak Area Ratio (NPAR), being the ratio of the peak areas for the PCV antigen peak and the internal standard peak, normalized for the amount of the internal standard used in the test. This result was compared to the result using a reference vaccine, leading to a Relative Potency value for the test article.

### 3.1 Phthalic Acid (PTA) Internal Standard Stock Solution Preparation

Approximately 25 mg of phthalic acid (ACS reagent grade, >99.5%) was accurately weighed into a 250 mL volumetric flask. The PTA was then dissolved and diluted to a volume of 250 mL with Mobile Phase A (purified water (ASTM Type I) with 1 mL/L Trifluoroacetic acid (TFA, HPLC grade)), and mixed well to yield a solution having a concentration of approximately 0.1 mg/mL.

### 3.2 HPLC Sample Preparation

An HPLC sample was prepared from the Porcine Circovirus Vaccine, Type 2, Killed Baculovirus Vector-Mycoplasma Hyopneumoniae Bacterin Reference Vaccine and triplicate samples were prepared from a vaccine production batch of Porcine Circovirus Vaccine, Type 2, Killed Baculovirus Vector-Mycoplasma Hyopneumoniae Bacterin vaccine. In each case, the vaccine at 20-25° C. was mixed well by inverting, and 4.0-mL was then pipetted into a 15-mL centrifuge tube. All samples were centrifuged at 29,000×g for 10 minutes at 4° C. The samples were inspected to ensure they partitioned into 2 layers. The centrifuge and rotor were cooled down to −10° C. and the samples were centrifuged at 29,000×g for 20 minutes at −10° C. The samples were inspected to ensure that the bottom (aqueous) layer was frozen solid.

The samples were then placed in crushed dry ice to keep them frozen. The top layer of each sample was removed by vacuum suction, and then each was allowed to return to 20-25° C. The samples were then sonicated for 5 minutes at approximately 20-25° C., submersed to at least sample level. 0.5 mL of an aqueous 80% Methanol Solution (HPLC methanol mixed with purified water) was added to the samples and mixed well by inverting each tube, and centrifuged at 29,000×g for 30 minutes at 4° C. The liquid was decanted from the tubes, and residual moisture and oil was wiped from the tubes using a clean cotton swab for each tube while being careful not to disturb the pellets.

A 2.0-mL aliquot of PTA internal standard diluting solution was pipetted into each sample tube. The samples were vortexed to loosen the pellet from the tube wall, and sonicated for 5 minutes in a water bath 20-25° C., submersed to at least sample level. This process was repeated for a maximum of 3 cycles of 5 minutes if the pellets had not visibly disintegrated and dissolved. The samples were stored at 20-25° C. until HPLC analysis, which was typically done within 24 hours after preparation.

### 3.3 HPLC Analysis Procedure

HPLC was conducted on an HPLC apparatus fitted with an Agilent 1100 HPLC pump, Agilent 1100 HPLC Autosampler, Agilent 1100 HPLC Fluorescence Detector, Agilent 1100 column heater, and an Agilent EZCHROM Elite Data Acquisition System. A YMC-Pack ODS-AQ column (250 mm×4.6 mm i.d., 5 μm particle size, 12 nm pore size) was used for sample separation. The column was maintained at 50° C. and pre-equilibrated by injecting the column with 100 μL, of sample followed by a blank run of Mobile Phase A (purified water (ASTM Type I) with 1 mL/L Trifluoroacetic acid (TFA, HPLC grade)). Consecutive samples were run on the column as pre-equilibration samples until three successive injections have a % Relative Standard Deviation (% RSD) of the Peak Area Ratios (PARs) of <5%. Each injection of a sample was followed by an injection (run) of Mobile Phase A, in order to prevent sample carryover. When a new column is used, multiple equilibration injections were found to be necessary.

Once the column was equilibrated, 100 μL aliquots of sample were injected onto the column, elution of which was achieved with a flow of 1 ml/minute of a gradient of mobile phases (A: purified water (ASTM Type I or equivalent) with 1 mL/L trifluoroacetic acid (TFA, HPLC grade); B: HPLC grade acetonitrile with 1 mL/L HPLC grade TFA) according to Table 13. The trifluoroacetic acid is added to the mobile phase to lower the pH and to serve as an ion-pair reagent. The antigen peak of interest is detected via fluorescence with excitation wavelength (λ) of 280 nm and emission wavelength (λ) of 350 nm.

TABLE 13
Elution Gradient for Porcine Circovirus/M. hyopneumoniae Vaccine

| Time (minutes) | % Mobile Phase A | % Mobile Phase B |
|---|---|---|
| 0 | 70 | 30 |
| 10 | 50 | 50 |
| 15 | 5 | 95 |
| 20 | 5 | 95 |
| 21 | 70 | 30 |
| 30 | 70 | 30 |

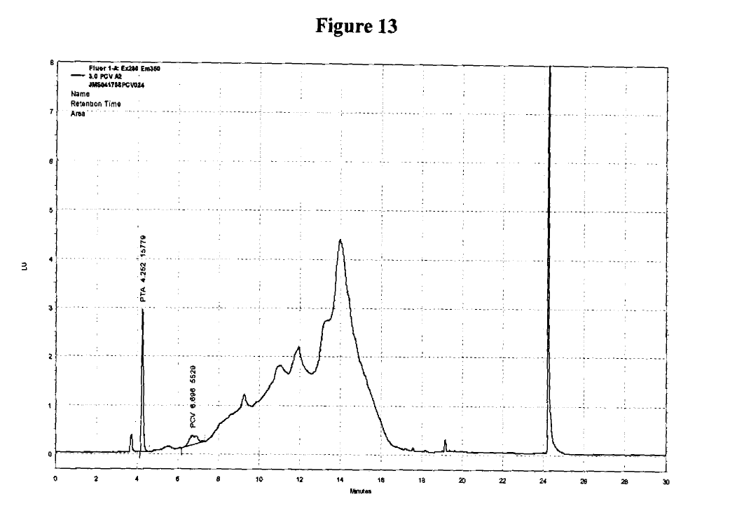

Examples of liquid chromatography chromatograms showing separation of the PCV antigen without and with the internal standard present in the HPLC sample are shown respectively in FIGS. 12 and 13. The retention time of the Porcine circovirus antigen is around 6.7 minutes. The retention time of the PTA internal standard is around 4.3 minutes. Identification of the peak corresponding to antigen was confirmed by comparing the PAGE pattern of material eluting off of the HPLC column to the PAGE pattern of production grade antigen. A monoclonal antibody known to bind the antigen was used to stain the PAGE gel for comparative visualization. Further gas chromatographic analysis (e.g., MALDI-TOF) of material digested with trypsin afforded the conclusion that the material emerging from the column at 6.7 minutes corresponded to the PCV antigen ORF2.

Retention of the antigen peak may be adjusted by changing the initial rate of the Mobile Phase B (e.g., faster rate shortens the retention time of the antigen peak). Retention of the PTA peak may be adjusted by changing the concentration of TFA in the mobile phase (e.g., higher concentrations of TFA increases the retention time of the PTA peak).

Quantization of the antigen protein peak is accomplished by the use of an internal standard (PTA) and the results may be reported as a PTA-weight normalized peak area ratio or concentration as PTA equivalents. This was necessary as no purified external standard was available. A PTA-weight normalized peak area ratio is calculated using the following formula:

Peak Area Ratio=[(Peak Area of Porcine Circovirus antigen)/(Peak Area of PTA)]×(wt. of PTA in mg/25)

The “wt. of PTA in mg” is the weight of PTA measured in mg that was used to prepare the HPLC sample.

For the Reference Vaccine and for each vaccine sample, the NPARs of the triplicate test samples are averaged and the % RSD can be calculated. The results can be recorded as the average NPAR. The Relative Potency (RP) of a test article can be calculated as the ratio of the average NPAR of the test article and the average NPAR of the Reference Vaccine.

### 3.4 Column Wash Procedure

The HPLC column should be washed periodically (recommended after every set of test samples) to avoid the buildup of residues on the column. The buildup of these residues on the column can cause peak shape deterioration and change the recovery of the antigen from the HPLC column.

To wash the column, flush the column for 30 minutes with Mobile Phase A/Mobile Phase B (5/95, v/v) at 50° C. and 2 mL/minute to remove any adjuvant residues. Then, while the column is maintained at 50° C., inject 100 μL of Mobile Phase A using the elution gradient of Table 14 at a flow rate of 1 mL/minute (Mobile Phase A: purified water (ASTM type 1) with 1 mL/L Trifluoroacetic acid (TFA, HPLC grade); Mobile Phase B: HPLC grade Acetonitrile with 1 mL/L HPLC grade TFA). The column wash procedure is repeated as necessary.

TABLE 14
Elution Gradient for Washing Column of Example 3

| Time | | % Mobile |
|---|---|---|
| (minutes) | % Mobile Phase A | Phase B |
| 0 | 70 | 30 |
| 2 | 40 | 60 |
| 4 | 70 | 30 |
| 6 | 40 | 60 |
| 8 | 70 | 30 |
| 10 | 40 | 60 |
| 12 | 70 | 30 |
| 14 | 40 | 60 |
| 16 | 70 | 30 |
| 18 | 40 | 60 |
| 20 | 70 | 30 |
| 22 | 40 | 60 |
| 24 | 70 | 30 |
| 26 | 40 | 60 |
| 28 | 70 | 30 |
| 30 | 40 | 60 |

All U.S. patents or published U.S. patent applications identified herein are hereby incorporated by their reference in their entirety.

1. A method of measuring antigen stability comprising:
i) gathering a first liquid chromatography measurement of antigen contained in a first sample prepared from a source of antigen;
ii) gathering a second liquid chromatography measurement of antigen contained in a second sample prepared from the source of antigen; and
iii) quantifying changes in the second liquid chromatography measurement as compared to the first liquid chromatography measurement thereby measuring antigen stability.

2. The method of claim 1, wherein an internal standard is added to said samples.

3. The method of claim 2, wherein said measurements are derived from recorded peaks showing the amount of light absorption or fluorescence emission of antigen and internal standard.

4. The method of claim 3, wherein said first liquid chromatography measurement is a ratio of the area under the peak of antigen of the first sample to the normalized area under the peak of internal standard of the first sample; and wherein said second liquid chromatography measurement is a ratio of the area under the peak of antigen of the second sample to the normalized area under the peak of internal standard of the second sample.

5. The method of claim 1, wherein the source of antigen is a vaccine batch.

6. The method of claim 5, wherein said samples are prepared by separating antigen from adjuvant in samples taken from the vaccine batch.

7. The method of claim 6, wherein said antigen is precipitated in the samples taken from the vaccine batch.

8. The method of claim 6, wherein said adjuvant is precipitated in the samples taken from the vaccine batch.

9. A method of measuring potency of antigen in a substance relative to the potency of a corresponding reference comprising:
i) gathering a first liquid chromatography measurement of antigen contained in a first sample prepared from the reference;
ii) gathering a second liquid chromatography measurement of antigen contained in a second sample prepared from the substance;
iii) comparing the second liquid chromatography measurement to the first liquid chromatography measurement thereby determining the potency of antigen in the substance relative to the potency of the corresponding reference.

10. The method of claim 9, wherein an internal standard is added to said samples.

11. The method of claim 10, wherein said measurements are derived from peaks showing the amount of light absorption or fluorescence emission of antigen and internal standard.

12. The method of claim 11, wherein said first liquid chromatography measurement is a ratio of the area under the peak of antigen of the first sample to the normalized area under the peak of internal standard of the first sample; and wherein said second liquid chromatography measurement is a ratio of the area under the peak of antigen of the second sample to the normalized area under the peak of internal standard of the second sample.

13. The method of claim 9, wherein said substance is a vaccine batch and said reference is a reference vaccine.

14. The method of claim 13, wherein said first sample and said second sample are respectively prepared by separating antigen from adjuvant in samples taken from the reference vaccine and the vaccine batch.

15. The method of claim 14, wherein said antigen is precipitated in the samples taken from the reference vaccine and the vaccine batch.

16. The method of claim 14, wherein said adjuvant is precipitated in the samples taken from the reference vaccine and the vaccine batch.

17. A method of qualifying a vaccine batch as a reference vaccine comprising the method of claim 13, wherein said vaccine batch is qualified as a reference vaccine when said second liquid chromatography measurement is at least the same as said first liquid chromatography measurement.

18. A method of requalifying a reference vaccine comprising the method of claim 1, wherein said source of antigen is a previously qualified reference vaccine and said reference vaccine is requalified when said second liquid chromatography measurement is at least the same as said first liquid chromatography measurement.
